(19) United States
(12) Patent Application Publication
(10) Pub. No.: US 2003/0163354 A1
(43) Pub. Date: Aug. 28, 2003

(54) Device for collecting and analyzing nutritional data and method therefor

(76) Inventor: Simon Shamoun, Kennesaw, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 09/764,383

(22) Filed: Jan. 19, 2001

(51) Int. Cl. G06F 17/60; G06F 7/00; G06F 17/30

(52) U.S. Cl. 705/3; 707/1

(57) ABSTRACT

A portable nutritional monitoring device wherein nutritional data can be scanned, entered and stored directly from product packaging for dietary intake analysis by health or weight conscious individuals wherein such analysis may be doctor prescribed, or may be collated for a target group and utilized as food consumption and market trending information, wherein said data may be subsequently analyzed and reported, and wherein the device may be integrated within a known personal data assistant (PDA) platform.

### TECHNICAL FIELD

The present invention relates generally to nutrition monitoring devices and, more specifically, to a portable data collection device capable of scanning nutritional data from product packaging, storing the data, performing subsequent analysis and reporting thereof, and a method therefor. The present invention is particularly useful in, although not strictly limited to, nutritional intake monitoring applications desiring compatibility and functionality within known personal data assistant (PDA), pocketsize and handheld PC platforms.

### BACKGROUND OF THE INVENTION

Individual interest in diet and health may be at an all time high. Various new forms of sports and exercise continue to be successfully introduced. Dietary guidelines are updated regularly as more information is gleaned about body function and biological performance. As a result, individuals demand, and regulations require, more nutritional data about foods.

While it has become simple to check packaged foods for levels of fats, carbohydrates, proteins, vitamins and minerals by simply reading the nutritional data on the label, assimilating that same information to monitor nutritional intake for a given time period can be arduous. For those individuals with a health condition requiring limited consumption of certain categories of foods, for those attempting weight-loss and for those with a sports achievement goal requiring massive consumption of certain types of foods, the most common method of nutritional monitoring is the personal diary. The diary, in its simplest form, is a hand written accounting of all foods consumed, including the transcribed nutritional data thereof. Categorical tallies provide summaries for meals, days, weeks or months. The time-consuming nature of the diary makes it disadvantageous for the majority of the population.

Electronic devices have been proposed to assist with nutritional analysis. Portable calculator-like devices are known in the art wherein a user enters a food item or food group via a keypad and nutritional reference data is accessed. Some store specific diet recommendations or restrictions and monitor keypad entered intake to provide a user with consumption guidance. Still others allow for keypad entry of exercise or can mate with an odometer for monitoring calorie expenditure. Each of these devices, however, is disadvantageous because a user must manually enter the food items or the nutritional information into the device by using a time-consuming, labor intensive and potentially error prone keypad.

Furthermore, even after entry is made, the entry must be compared with a database of stored nutritional data. Unfortunately, it is virtually impossible for such a database to include all available food products, in addition, while it has been suggested that a general food reference catalog could cover those items not included in such a database, it is not likely that access to such a catalog could provide complete information for all consumables. Such a catalog, if it could exist, would be cumbersome to transport and virtually impossible to keep current given the swift entry of new products into the marketplace. Thus, an individual monitoring his nutritional intake through the use of one of these devices would likely still have to create some manual diary records and calculations because a complete dietary history would be unable to be maintained in the device.

Alternative nutrition tracking devices have been proposed wherein a scanner is utilized instead of a keypad to alleviate the disadvantage of manual entry. However, although these devices can scan a universal product code (UPC) to identify a food product, they must still access a database of stored nutritional data. The inherent inability of such a food product database to be complete makes these scanning type devices disadvantageous.

Furthermore, even if the foregoing devices did allow for easy data entry and for access to a database containing every possible food item, the fact that they are stand-alone nutrition tracking devices with no other features, other than perhaps those of a simple calculator, is clearly disadvantageous. With cellular telephones, paging devices, wallets, purses, appointment books, keys and the many other indispensables that the typical individual already has to carry on his or her person, yet another device is not likely to be welcomed.

Therefore, it is readily apparent that there is a need for a device for collecting and analyzing nutritional data wherein nutritional data can be scanned and entered directly from product packaging and wherein the device could be integrated into an already available portable electronic apparatus thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a portable data collection device capable of scanning nutritional information from product packaging, storing the data and performing subsequent analysis and reporting thereof.

According to its major aspects and broadly stated, the present invention is a nutritional monitoring device integrated within a known personal data assistant (PDA), pocketsize and/or handheld PC platform (hereinafter collectively referred to as PDA), wherein nutritional data can be scanned and entered directly from product packaging for dietary intake analysis by health or weight conscious individuals wherein such analysis may be doctor prescribed or may be collated for a target group and utilized as food consumption and market trending information.

More specifically, the present invention is a method of portable nutritional monitoring wherein daily food intake is recorded, nutrition facts are digitally transferred, recorded and trended, and calories, fats, proteins, carbohydrates, vitamins and minerals are monitored. Recordation is accomplished wherein a known device, such as a personal data assistant (PDA), is equipped with a scanner and appropriate software programming capable of either reading and interpreting the standard nutrition facts table included on product packaging or reading and interpreting a novel nutrition facts bar code or other suitable graphic representation proposed herein for product packaging. Recorded information is then stored and categorized by date and meal, thereby monitoring individual daily intake. Also stored are Recommended Daily Allowance (RDA) guidelines to be utilized as reference standards for comparison, franchise food archives to provide nutritional data for common restaurant menus, fresh food indexes to provide information for fruits and vegetables, and personally input recipes to allow for home prepared meal analysis. Device synchronization permits downloading of daily values for computation of weekly, monthly or annual dietary intake totals.

A feature and advantage of the present invention is the ability of such a device to provide a nutritional monitoring device that is integrated into a known personal electronic accessory.

A feature and advantage of the present invention is the ability of such a device to provide an automated method for collecting nutritional data from a food package.

A feature and advantage of the present invention is the ability of such a method to provide a portable nutritional diary having access to individual dietary intake restrictions and goals.

A feature and advantage of the present invention is the ability of such a method to provide for direct scanning and interpretation of the nutritional facts table on a food product package.

A feature and advantage of the present invention is the ability of such a device to digitally transfer, record and trend food consumption and market trend data.

A feature and advantage of the present invention is the ability of such a method to provide a novel bar code or graphic representation encoding nutrition facts data for food items.

A feature and advantage of the present invention is the ability of such a device to categorize and maintain individual dietary intake records.

A feature and advantage of the present invention is the ability of such a device to permit the creation of personal recipe files wherein home-prepared meals can be selected to fulfill calculated dietary deficiencies.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a method of portable nutrition monitoring according to a preferred embodiment of the present invention showing a nutritional monitoring device integrated within a known personal data assistant (PDA) platform, a selected food product having nutritional facts for data entry and a desktop computer for permanent data storage.

FIG. 2 is a known Nutrition Facts table.

FIG. 3 is a flowchart of a method for collecting and analyzing nutritional data according to a preferred embodiment of the present invention showing a non-specific dietary intake assessment plan.

FIG. 4 is a flowchart of a method for collecting and analyzing nutritional data according to a preferred embodiment of the present invention showing a specific dietary need management plan.

FIG. 5 is a flowchart of a method for collecting and analyzing nutritional data according to a preferred embodiment of the present invention showing user-creation of a selectable recipe index having nutritional data.

FIG. 6 is a flowchart of a method of collecting and analyzing nutritional data according to a preferred embodiment of the present invention showing user food selection assistance based on RDA analysis.

FIG. 7 is a flowchart of a method of collecting and analyzing nutritional data according to a preferred embodiment of the present invention showing user food selection assistance based on specific dietary need analysis.

FIG. 8 is a flowchart of a method for collecting and analyzing nutritional data according to an alternate embodiment of the present invention.

### DETAILED DESCRIPTION OF THE PREFERRED AND ALTERNATE EMBODIMENTS

In describing the preferred and alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

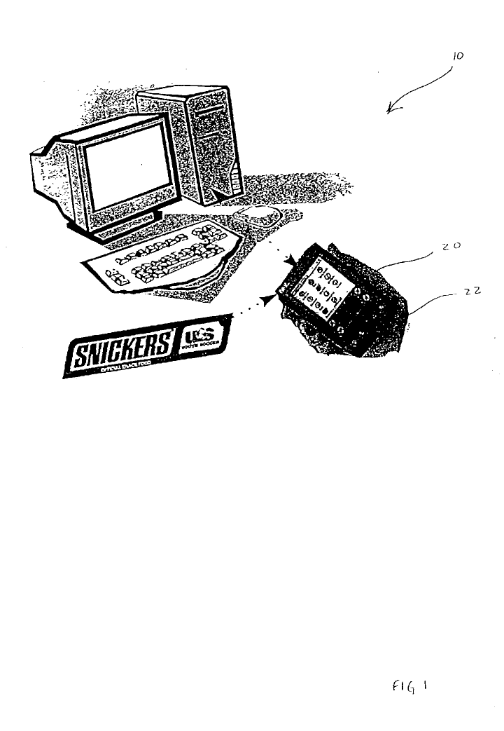

Referring now to FIG. 1, the present invention is a method of portable nutritional monitoring 10 wherein food intake nutritional facts are recorded using a portable nutritional monitoring device 20 preferably having data import means 40, appropriate data import, translation and utilization software 60, data storage means 80 and data transfer means 100.

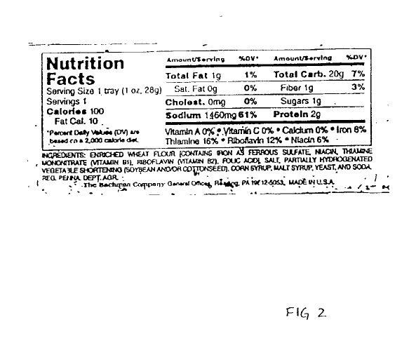

Preferably, portable nutritional monitoring device 20 is integrated within a personal data assistant (PDA) and/or a pocket or handheld PC (hereinafter referred to collectively as a PDA) 22, such as, for exemplary purposes only, those sold under the trademark “Palm Pilot” or “Handspring Visor.” Data import means 40 is preferably optical scanner 42 Preferably, optical scanner 42 is linked to PDA 22 whereby scanned data may be transmitted thereto. Preferably, optical scanner 42 operates utilizing known frequencies, such as, for exemplary purposes only, infrared, ultra-violet, visible light, radio or microwave. Given the parameters and desired functionality, one skilled in the art would be able to write software 60 enabling optical scanning means 42 to read and transfer known “Nutrition Facts” table data, such as shown in FIG. 2, wherein the “Nutrition Facts” table data is translated or interpreted by software 60 and stored within data storage means 80.

Preferably, data storage means 80 is linked to PDA 22 whereby stored data may be input or accessed therethrough Data storage means 80 is preferably digitally configured and dimensioned to retain dietary intake nutritional data. Given the parameters and desired functionality, one skilled in the art would be able to write software 60 enabling categorization of dietary intake nutritional data by date and meal wherein categorized data is preferably accessible with reference thereto. Preferably, data storage means 80 is digitally configured to store Recommended Daily Allowance (RDA) guidelines. Given the parameters and desired functionality, one skilled in the art would be able to write software 60 enabling access to and utilization of RDA guidelines as comparison reference standards. Preferably, data storage means 80 is digitally configured to retain franchise food nutritional data archives. Given the parameters and desired functionality, one skilled in the art would be able to write software 60 enabling access to and utilization of franchise food nutritional data archives as a reference database for common restaurant menus. Preferably, data storage means 80 is digitally configured to retain fresh food nutritional data indexes. Given the parameters and desired functionality, one skilled in the art would be able to write software 60 enabling access to and utilization of fresh food nutritional data indexes as a reference index for fruits and vegetables. Preferably, data storage means 80 is digitally configured to retain user-created recipe files. Given the parameters and desired functionality, one skilled in the art would be able to write software 60 enabling user input of and access to home-prepared meal recipes.

Preferably, data transfer means 100 is PDA synchronization known in the art wherein downloading of stored data is enabled to permit desktop computations, such as, for exemplary purposes only, reporting of weekly, monthly or annual dietary intake totals.

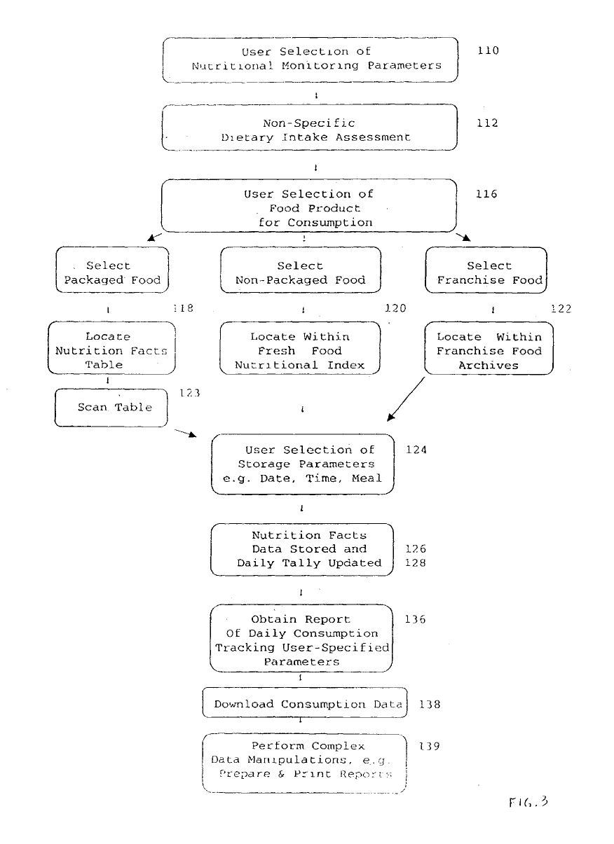

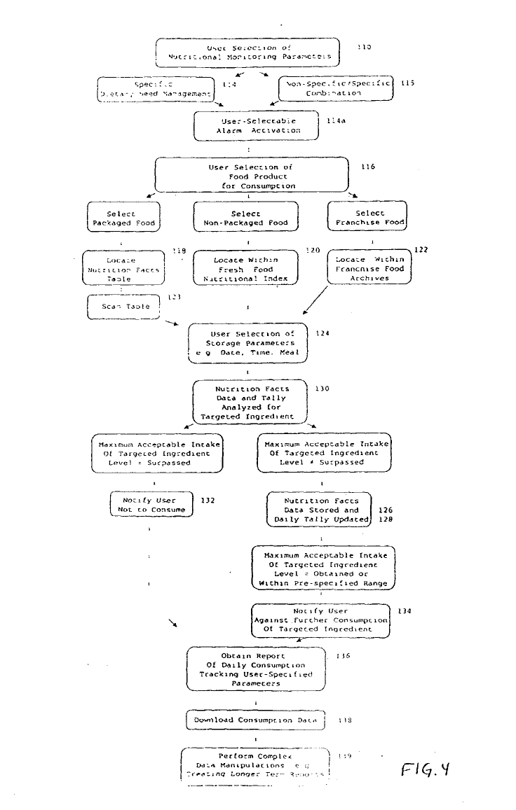

Referring now to FIG. 3 and FIG. 4, the method of portable nutritional monitoring 10 is preferably initiated upon user-selection of nutritional monitoring parameters 110. Parameters 110 preferably include non-specific dietary intake assessment 112, as best seen in FIG. 3, specific dietary need management 114 or a combination thereof 115, as best seen in FIG. 4. Non-specific dietary intake assessment 112 preferably enables monitoring of consumption of those ingredients quantified in a “Nutrition Facts” table, such as, for exemplary purposes only, overall calories, fat calories, total fat, saturated fat, cholesterol, sodium, total carbohydrate, fiber, sugars, protein, vitamins and minerals. Specific dietary need management 114 preferably enables targeted tracking of a designated food ingredient for monitoring specific medical conditions, such as, for exemplary purposes only, sugar for diabetes, cholesterol or sodium for a heart condition, or iron for anemia. Preferably, a selectable alarm 114a can notify the user when he or she reaches a user-programmable maximum acceptable intake level of the specifically managed dietary ingredient.

A food product is selected for consumption 116 by a user. To obtain nutritional data for a packaged food product, the “Nutrition Facts” table is located thereon 118. Preferably, optical scanner 42 reads the table 123, transferring the data contained therein to portable nutritional monitoring device 20. To obtain nutritional data for a fruit, vegetable or other non-packaged food, the fresh food nutritional data index is referenced 120. The fresh food item to be consumed is located within the index and is selected. To obtain nutritional data for a franchise food, the franchise food archive is referenced 122.

Once the appropriate nutritional data corresponding to the food to be consumed is displayed, storage parameters specifying date, meal and portion are selected 124. If non-specific dietary intake assessment has been chosen, the nutrition facts data is stored 126 for the date, meal and portion specified wherein the daily tally is updated 128 to reflect the consumption. If specific dietary need management has been chosen, the nutrition facts data is compared to the daily tally and analyzed for the targeted ingredients' level 130. If the programmed maximum acceptable intake level of the specifically managed dietary ingredient would be surpassed with consumption of the selected food item, the user is notified and advised not to proceed 132. If the programmed maximum acceptable intake level of the specifically managed dietary ingredient would not be surpassed with consumption of the selected food item, the nutrition facts data is stored for the date, meal and portion specified wherein the daily tally is updated to reflect the consumption whereupon the selectable alarm can notify the user if the programmed maximum acceptable intake level of the specifically managed dietary ingredient is reached 134, or is within a specified range.

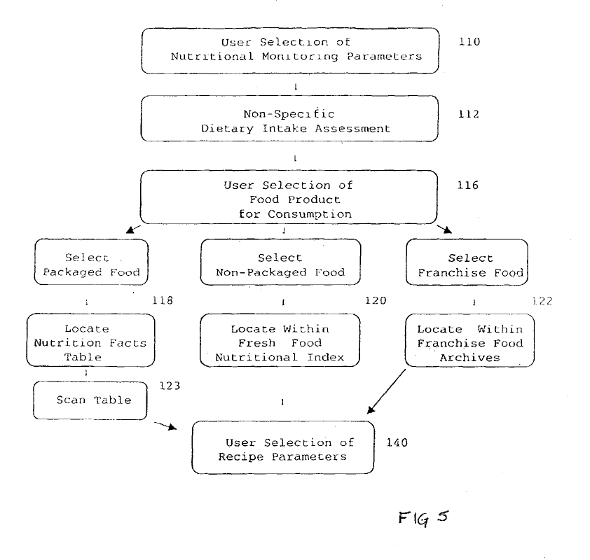

If a user is preparing a home cooked meal, he or she may utilize a combination of the scanned “Nutrition Facts” data and fresh food index nutritional data. The resulting information is preferably user-titled and stored in a recipe index 140, as best seen in FIG. 5.

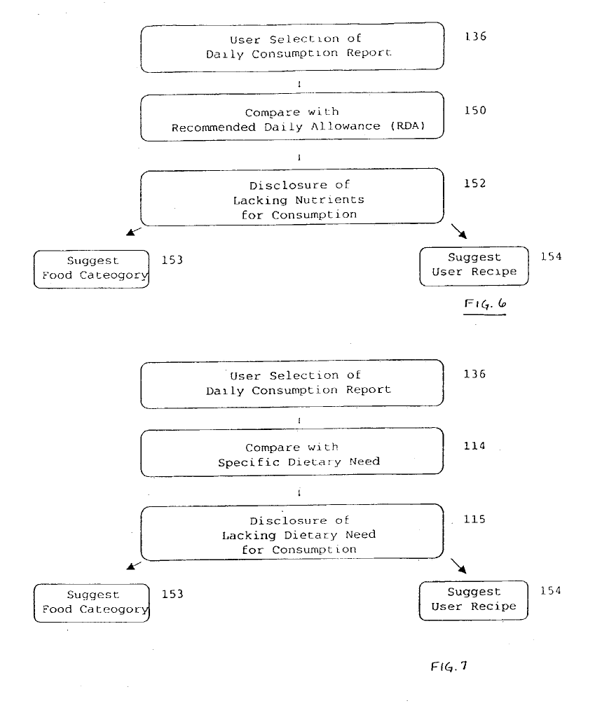

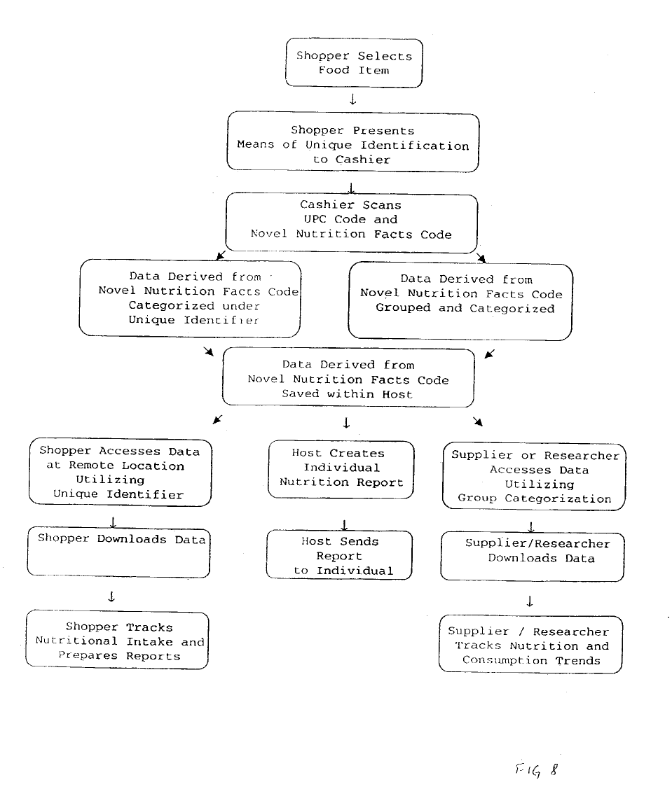

If a user is preparing to consume a meal, he or she may utilize the nutritional monitoring device 20 to assist with the choice. Consumption tallies for the day are preferably compared to Recommended Daily Allowance (RDA) guidelines 150, as best seen in FIG. 6. Those nutrients remaining to be consumed are preferably disclosed 152, with suggested food categories 153 preferably provided to enable satisfaction of the guidelines. Wherein a user is planning to cook a meal, preferably the RDA comparison feature is IS used to suggest a previously stored recipe 154 to fulfill the incomplete dietary need. Similar need assessment and fulfillment suggestions 115, as best seen in FIG. 7, are preferably available for user-selected dietary needs, such as, for exemplary purposes only, increased calcium for nursing mothers or increased fiber for prostate health.

Preferably, portable nutrition monitoring device 20 summarizes and reports daily consumption 136, preferably tracking user-specified parameters. Preferably, synchronization 138 enables consumption data to be transferred to a host computer source wherein more complex manipulation and computation takes place 139, such as, for exemplary purposes only, the creation of weekly, monthly and yearly consumption reports.

Preferably, suppliers and producers of packaged foods and medical researchers could select random participants to utilize portable nutrition monitoring device 20 thereby obtaining direct-stored nutritional data from target groups enabling analysis of nutrition and consumption trends.

In an alternate embodiment, given the parameters and desired functionality, one skilled in the art could write software 60 enabling optical scanning means 42 to read and transfer known non-quantified ingredients data, such as shown in FIG. 2, wherein the ingredients data is translated or interpreted by software 60 and stored within data storage means 80. Wherein ingredients data is stored therein, portable nutritional monitoring device 20 could be user-programmed to alert the user of a particular ingredient of interest due to allergies or potential drug-interaction.

In an alternate embodiment, the present invention is a method of portable nutritional monitoring 10 wherein food intake nutritional facts are recorded using a portable nutritional monitoring device 20 preferably having data import means 40, appropriate data import, translation and utilization software 60, data storage means 80 and data transfer means 100 wherein data import means 40 is a scanner 42 wherein, given the parameters and desired functionality, one skilled in the art would be able to write software 60 enabling scanner 42 to read, import and translate a novel machine readable code, symbol or bar code encoding nutrition facts therein, wherein the machine readable nutrition facts code could be provided on product packaging and in a reference source wherein fresh foods and franchise food nutritional facts could be scanned directly therefrom.

The novel machine readable code, symbol or bar code encoding nutrition facts therein could be located proximate to the Nutrition Facts table for ease of reference thereto, or could be located proximate to the UPC bar code to enable the scanning of both codes substantially simultaneously 160. Wherein the novel machine is readable code, symbol or bar code encoding nutrition facts therein is located proximate to the UPC bar code, scanning thereof could result in the accumulated storage of nutrition data by the host scanner. Wherein the host scanner is a known commercial vendor having a cashier-type terminal, the individual user could provide a unique identifying means at some point before the conclusion of the scanning event. The unique identifying means could be utilized by the user to access the personally categorized nutritional data stored within the host wherein the data could be downloaded wherein more complex manipulation and computation could take place, such as, for exemplary purposes only, the creation of weekly, monthly and yearly consumption reports.

The unique identifying means could be a personal code wherein the user enters the code into a keypad or the unique identifying means could be obtained from a magnetic strip on a card, such as a store club membership card, bank card, credit card or other type of encoded identification card wherein the nutritional data could be automatically processed and stored for individuals utilizing such cards to make their purchases.

At the individual user's request, card providers, such as banks or stores, could provide a monthly nutritional summary within each billing statement thereby providing nutritional tracking to individuals without access to a computer or a portable nutritional monitoring device.

In another alternate embodiment, portable nutritional monitoring device 20 could be a calculator, wrist worn computer or a mobile communication device, such as, for exemplary purposes only, a cellular telephone, paging device.

In another alternate embodiment, data import means 10 for portable nutritional monitoring device 20 could be a keypad, keyboard or other manual touch-type data entry system.

In another alternate embodiment, optical scanner 42 could be integral to portable nutritional monitoring device 20, not linked thereto.

In another alternate embodiment, portable nutritional monitoring device 20 could be a PDA or a wrist-worn computer wherein optical scanner 42 could read and input known UPC barcodes and wherein nutritional data could be accessed from a reference database thereby.

In another alternate embodiment, portable nutritional monitoring device 20 could provide a database of recipes wherein a user could be assisted thereby in making a meal selection by referencing the nutritional data thereof.

In another alternate embodiment, data transfer means 100 could be a cable or wireless connection.

In another alternate embodiment, a website could be provided for users of portable nutritional monitoring device 20 wherein nutritional tracking reports could be compared and goals could be monitored.

In an additional alternate embodiment, a health meter port is incorporated into portable nutritional monitoring device 20, wherein any one of a multitude of cardiac sensory devices, such as, for exemplary purposes only, a chest belt, a finger sensor or a hand grip sensor, may be plugged therein to receive cardiac information such as heart rate, and display and/or store the cardiac information. An oxygen saturation sensor may also be utilized to track and/or display the user's oxygen saturation levels. It is also contemplated that the cardiac sensor may be an integral part of portable nutritional monitoring device 20, wherein device 20 may simply be held in contact with the user to monitor cardiac information.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A portable nutritional data device for reading a machine-readable indicia, comprising:
a portable data processing platform;
means for inputting data;
means for retrievably storing data; and
means for displaying data,
wherein the machine-readable indicia represents nutritional information.

2. The portable nutritional data device of claim 1, wherein the machine-readable indicia is the commonly available Nutritional Facts Data.

3. The portable nutritional data device of claim 1, wherein the machine-readable indicia is a preprinted bar code contained on a food package.

4. The portable nutritional data device of claim 1, wherein said means for inputting data is an optical scanner capable of reading the machine-readable indicia.

5. The portable nutritional data device of claim 1, wherein said means for inputting data is a keypad.

6. The portable nutritional data device of claim 1, wherein said portable data processing platform is a personal data assistant.

7. The portable nutritional data device of claim 1, wherein said portable data processing platform is a handheld PC.

8. The portable nutritional device of claim 1, wherein said means for displaying data is a screen.

9. The portable nutritional device of claim 1, wherein said means for displaying data is a printer.

10. The portable nutritional device of claim 1, wherein said means for retrievably storing data is a digital storage medium.

11. The portable nutritional device of claim 10, wherein said means for retrievably storing data is read-only-memory.

12. The portable nutritional device of claim 10, wherein said means for retrievably storing data is random-access-memory.

13. The portable nutritional device of claim 10, wherein said means for retrievably storing data is a data hard drive.

14. The portable nutritional data device of claim 1, wherein said means for retrievably storing data further comprises categorical data of recommended daily nutritional allowances.

15. The portable nutritional data device of claim 1, wherein said means for retrievably storing data further comprises nutritional data for franchise food items.

16. The portable nutritional data device of claim 1, wherein said means for retrievably storing data further comprises nutritional data for fresh food.

17. The portable nutritional device of claim 1, wherein said means for retrievably storing data further comprises categorical data of user-created recipe data.

18. The portable nutritional device of claim 1, further comprising user stored personal health information.

19. The portable nutritional device of claim 18, wherein said user stored personal health information pertains to diabetes.

20. The portable nutritional device of claim 18, wherein said user stored personal health information pertains to high blood pressure.

21. The portable nutritional device of claim 18, wherein said user stored personal health information pertains to heart disease.

22. The portable nutritional device of claim 1, further comprising a user-selectable audible signal.

23. The portable nutritional device of claim 22, wherein said audible signal is activated in response to the exceeding of a maximum acceptable intake level for said specifically managed dietary need.

24. The portable nutritional data device of claim 1, wherein said readable indicia is a readable symbol.

25. The portable nutritional device of claim 22, wherein said audible signal is activated in response to allergy inducing edible.

26. The portable nutritional device of claim 22, wherein said audible signal is activated in response to potentially drug-interacting edible.

27. The portable nutritional data device of claim 1, wherein said portable data processing platform is a calculator.

28. The portable nutritional data device of claim 1, wherein said portable data processing platform is a wrist worn computer.

29. The portable nutritional data device of claim 1, wherein said portable data processing platform is a mobile communication device.

30. The portable nutritional data device of claim 29, wherein said mobile communication device is a cellular telephone.

31. The portable nutritional data device of claim 29, wherein said mobile communication device is a paging device.

32. The portable nutritional data device of claim 1, wherein said means for inputting data is a stylus pad.

33. A portable nutritional data device for reading a machine-readable indicia, comprising:
a portable data processing platform;
an optical scanner capable of reading the machine-readable indicia;
a digital storage medium having read-only-memory, random-access-memory and a data hard drive;
a display; and
a user-selectable audible signal,
wherein the machine-readable indicia is Nutritional Facts Data.

34. A method of portable nutritional monitoring, comprising the steps of:
a) scanning a machine-readable indicia, wherein said indicia indicates nutritional information;
b) storing said nutritional information in a digital medium;
c) comparing said stored nutritional information with given user preferred data; and
d) displaying said compared nutritional information to a user.

35. The method of portable nutritional monitoring of claim 34, wherein said user preferred data is the United States Recommended Daily Allowance guidelines.

36. The method of portable nutritional monitoring of claim 34, wherein said user preferred data is periodic user nutritional limitations.

37. The method of portable nutritional monitoring of claim 34, further comprising the step of categorizing said nutritional information.

38. The method of portable nutritional monitoring of claim 34, wherein said machine-readable indicia is the Nutritional Facts Data.

39. The method of portable nutritional monitoring of claim 34, wherein said machine-readable indicia is a bar code.

40. The method of portable nutritional monitoring of claim 39, wherein said bar code is contained on a food packaging.
